(19) United States
(12) Patent Application Publication
(10) Pub. No.: US 2002/0100797 A1
(43) Pub. Date: Aug. 1, 2002

(54) Gift card envelope

(76) Inventors: James R. Hollingsworth, Broadview Heights, OH (US); Paul Masdeu, Coral Gables, FL (US); Ronald Heathcott, Arlington, TX (US)

Correspondence Address: Patrick J. Tracy, Hodgson, Russ LLP, Suite 2000, One M&T Plaza, Buffalo, NY, 14203-2391, US

(21) Appl. No.: 09/775,427

(22) Filed: Feb. 1, 2001

(51) Int. Cl. B42D 15/00; B65D 75/00

(52) U.S. Cl. 229/92.8; 206/806

(57) ABSTRACT

This invention relates to a gift card supporting a prepaid credit card. The gift card may consist of single or multiple panels. The credit card is secured to the gift card, or may be contained in a pocket formed by multiple panels of the card. The gift card may contain one or more accent apertures, highlighting one or more areas of the credit card. It may also contain one or more operational slots depending on the combination of types of credit cards and gift cards. The multiple panel cards are securely affixed by a closure mechanism, ensuring that the credit card will remain inside the gift envelope.

### BACKGROUND OF THE INVENTION

1. Field of the Invention

The present invention relates to a card envelope device supporting a prepaid card.

2. Prior Art

There has been a need to develop a promotional piece which can support a prepaid credit card or other promotional card. Previous attempts in this area have produced promotional pieces of cumbersome construction including cards constructed by complicated manufacturing processes, including folding and gluing. These processes are disclosed in the prior art.

U.S. Pat. No. 5,133,496 to Davidson et al. discloses a three panel combination including card and gift pouch. This device includes three panels arranged side-by-side and separated by fold lines. The third panel folds onto the intermediate panel and has side flaps that are secured to the intermediate panel forming a gift pouch with access along a fold line. The first panel is then folded about a fold line onto the gift pouch and is sealed thereto by adhesive on a panel edge margin. A closed path line of perforations is provided in the third panel to receive a greeting card message, and the like. To manufacture the piece, this invention requires extensive cutting and gluing which is not required in the current invention.

U.S. Pat. No. 5,629,977 to Fonseca discloses a greeting card assembly having a prepaid telephone calling card provided in conjunction with a greeting card. An envelope having an inside pocket receives the card and a unique visually discernable calling card access identifier. The liner is attached to the envelope and the access identifier is affixed to the liner in the envelope. The prepared card gift envelopes of this invention do not include a greeting card separate from the envelope. This invention as well requires extensive cutting and gluing, whereas the gift envelope does not.

U.S. Pat. Nos. 3,508,702 to Kaiser, 3,773,251 to Hadick and 3,999,700 to Chalmers describe various credit card mailer devices. In each of these devices, the credit card is secured inside a carrying member separate from an envelope. The carrying member including the credit card is then inserted into the envelope to complete the assembly. In the card gift envelope of this invention, there is no separate carrying member for the prepaid card apart from the envelope.

U.S. Pat. No. 142,405 to McAnulty discloses a letter envelope having a tab of a first panel received in a slit of a third panel to close the envelope. In this invention the closure means is destroyed by opening the closed envelope. The gift card can be opened and closed a number of times without affecting the inserting of the closure mechanism.

Therefore, as can be seen by the prior art, there still is a need to develop a gift card envelope which can be used for a variety of credit cards and can be readily manufactured for a number of different applications.

### SUMMARY OF THE INVENTION

According to the present invention, a gift card package is formed from a generally rectangular sheet paper or cardboard base as a flat single panel or also may consist of a card with three panels. For the embodiment which consists of three panels, it has a first portion, a second intermediate portion and a third portion opposite the first portion. The first portion has a tab which is received in a slit provided in the third portion when the first and second portions are folded together towards each other, to overlay the intermediate panel. In this manner, a prepaid card secured to an inner surface of the second or third portion is enclosed inside the envelope with the tab of the first portion received in the slit of the third portion. In either embodiment, the intermediate panel in the case of a three panel card, or the center portion of the flat card may contain slots for UPC barcode scanning or barcode activation.

The foregoing and additional advantages and characterizing features of the present invention will become clearly apparent upon reading of the ensuing description together with the included drawings wherein:

### BRIEF DESCRIPTION OF THE DRAWINGS

FIG. 1 in a perspective view showing an embodiment of the gift envelope form as it is cut from the paper stock.

FIG. 2 shows an embodiment of the card partially closed with the gift card attached to the lower form.

FIG. 3 shows an embodiment of the card with the first flap folded with the card positioned between two folds of the card.

FIG. 4 shows an embodiment of the card completely closed with the closure tab inserted into the closure slot.

FIG. 5 shows a section cut along Axis 5-5 in FIG. 4 depicting the card in the closed position, detailing the arrangement of the prepaid card and the card panels.

FIG. 6 shows a respective view of a second embodiment of the gift card.

FIG. 7 shows the second embodiment of the card partially closed, with the gift card attached to the lower panel.

FIG. 8 shows the second embodiment of the card partially closed, with the lower flap folded with the gift card positioned between two folds.

FIG. 9 shows the second embodiment of the card completely closed with the closure tab inserted in the closure slot.

FIG. 10 shows a section cut along Axis 10-10 in FIG. 9 depicting the card in the closed position detailing the arrangement of the prepaid card and card panels.

FIG. 11 shows a perspective view of the rear face of the center panel of the gift card depicting the activation barcode and the UPC access slots.

FIG. 12 shows a perspective view of a third embodiment of the gift card.

FIG. 13 shows the third embodiment of the card 3 partially closed, with the card tucked between two panels of the card.

FIG. 14 shows the third embodiment of the card completely closed, with the closure tab inserted in the closure slot.

FIG. 15 shows a section cut along Axis 15-15 in FIG. 14 depicting the third embodiment of the card in the closed position detailing the arrangement of the prepaid card and the panels of the gift card.

FIG. 16 shows a perspective view of a fourth embodiment of the gift card containing a slot for UPC barcode access.

FIG. 17 shows a perspective view of the fourth embodiment of the gift card with a credit card attached.

FIG. 18 shows a section cut along axis 8-8 in FIG. 17 depicting the arrangement of the prepaid card and gift card panels, in the fourth embodiment.

FIG. 19 shows a plan view of the rear side of the fifth embodiment of the gift card, containing an attached credit card.

FIG. 20 shows a side elevation view of the fifth embodiment containing an attached credit card.

### BEST MODE FOR CARRYING OUT THE INVENTION

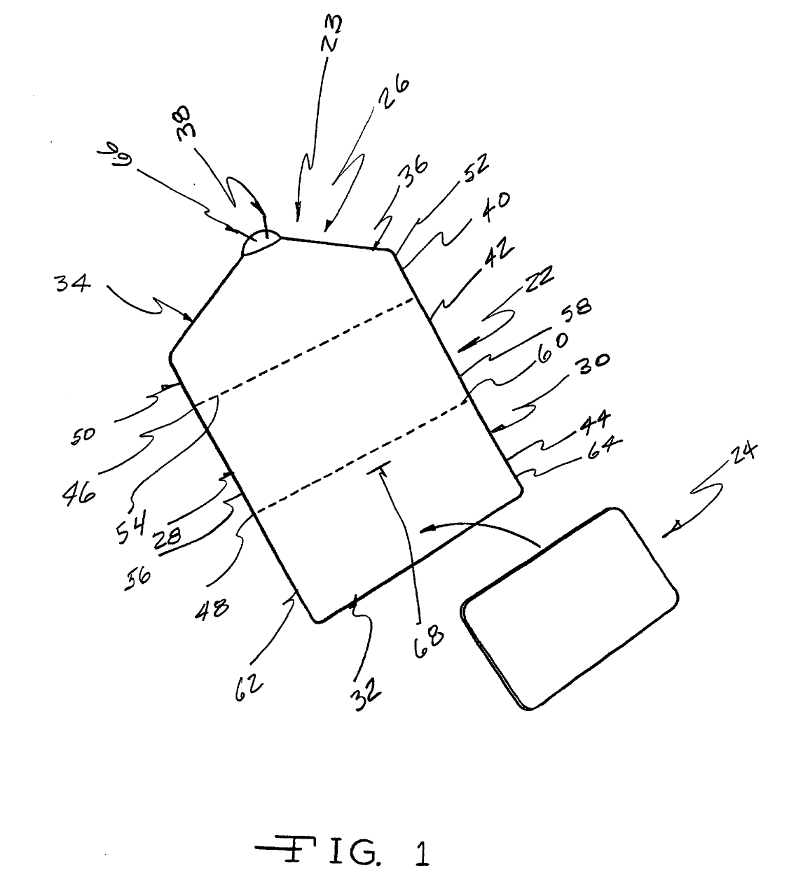

Turning now to the drawings, FIG. 1 shows the first embodiment of the prepaid gift envelope 22 according to the present invention. The gift envelope 22 houses a prepaid card 24, which can be a prepaid credit card, a prepaid debit card and the like. It can be appreciated by those skilled in the art that an optimum grade of paper can be used to construct the main body 26. The preferred grade of paper is SBS 14 pt, although other papers are satisfactory.

Now in FIGS. 1 thru 5, the gift envelope consists of spaced apart edges 28 and 30, extending downward and meeting with lower edge 32 at rounded corners. The side edges 28 and 30 extend up to and meeting with acute angular edges 34 and 36 at rounded corners. The angle of incidence of side edge 28 and left angular edge 34, and side edge 30 and right angular edge 36 are the same and less than 90°. The left angular edge extends from the intersection of edge 28 and left angular edge 34, extending up to an apex 38 formed by the intersection of left angular edge 34 and right angular edge 36. The right angular edge extends from the intersection of edge 30 and right angular edge 36, extending up to the apex 38 formed by the intersection of left angular edge 34 and right angular edge 36.

The card 22 consists of three panels 40, 42, and 44, separated by first and second lines of fold 46 and 48. The lines of fold 46 and 48, are parallel to lower edge 32 and are parallel to each other. The first fold line 46 intersects side edges 28 and 30, and is provided at about the one-third point of the length of the card. It separates the first and second panels 40 and 42. The second fold line 48 intersects side edges 28 and 30, and is provided at about the two-thirds point of the length of the card. Fold line 48 separates the second and third panels 42 and 44. The lines of fold 46 and 48 may be perforated.

The first panel 40 can be further described by spaced apart edges 50 and 52 extending to and meeting with a lower edge 54, which coincides with the first line of fold 46. The first panel 46 is further defined by spaced apart side edges 50 and 52 extending to and meeting with the acute angular edges 34 and 36 at rounded corners where the angles of incidence of side edge 50 and left angular edge 34, and side edge 52 and right angular edge 36 is less than 90°. Acute angular edges 34 and 36 are the same length. The left angular edge extends from the intersection of edge 50 and left angular edge 34, extending up to the apex 38, formed at the intersection of left angular edge 34 and right angular edge 36. The right angular edge extends from the intersection of edge 52 and right angular edge 36, extending up to apex 38, formed at the intersection of left angular edge 34 and right angular edge 36.

The second panel 42 can be further defined by spaced apart edges 56 and 58, extending to and meeting with upper and lower edges 54 and 60. Edges 54 and 60 coincide with lines of fold 46 and 48.

Also, the third panel 44 can be further defined by spaced apart edges 62 and 64, extending to and meeting with lower edge 32 at rounded corners. Lower edge 32 is parallel to lines of fold 46 and 48. Edges 62 and 64 further extend to and meet with upper edge 60, which coincides with the second line of fold 48. The upper edge 60 is parallel to lower edge 32.

A tab 66, is die cut at the same time the main body 23 is formed from paper stock, in a semi-circular shape. The midpoint of the tab is equi-distant between side edges 50 and 52 and is located about the proximate location of apex 38 in the first panel. A corresponding slit 68, equally distant from edges 62 and 64 is also located on the midpoint of the card 22, which coincides with the midpoint of the tab, located in the third panel. The slit can take the form of a T-shape. It can be appreciated by those skilled in the art that the closure of the prepaid card can take a number of shapes and the tab/T-slit combination is shown for illustrative purposes only.

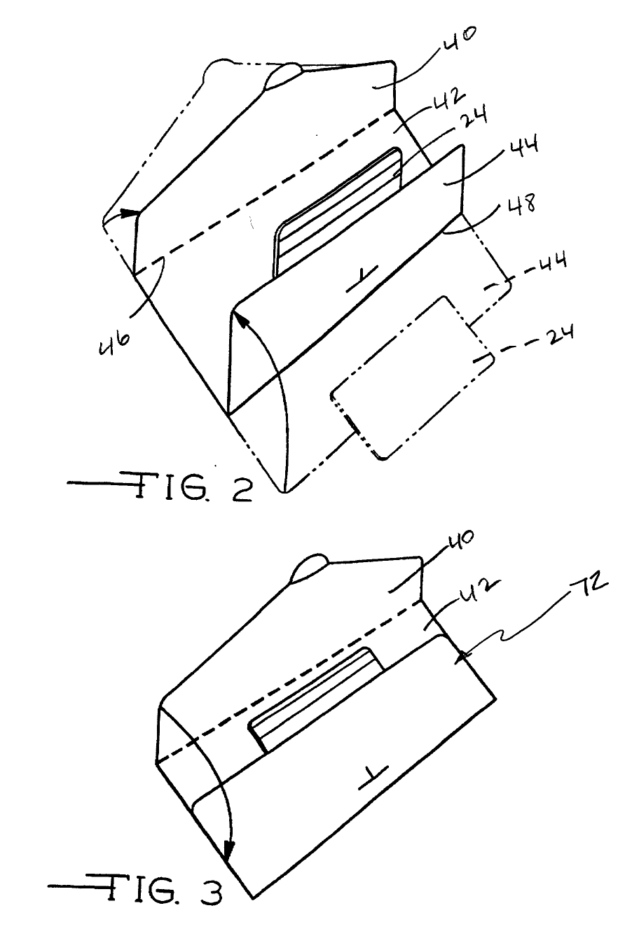

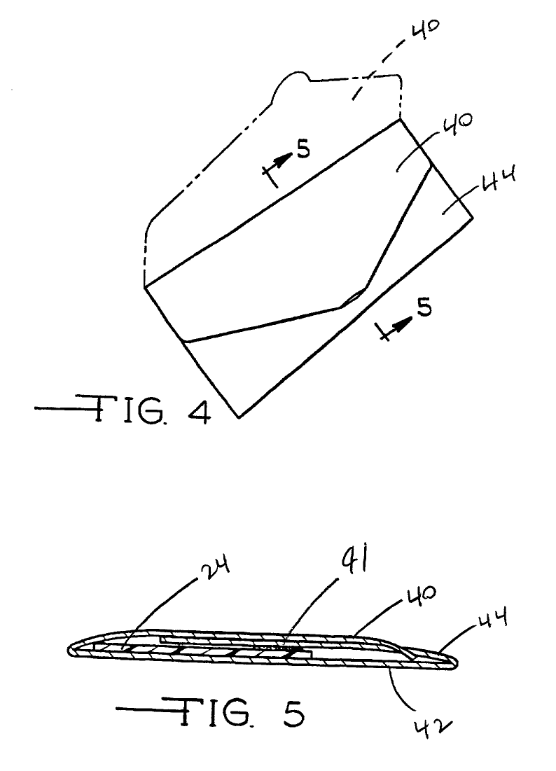

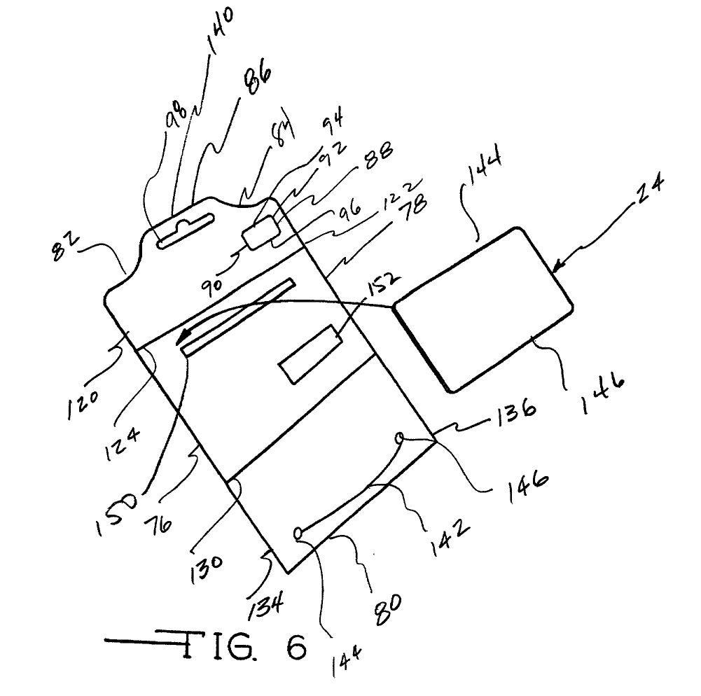

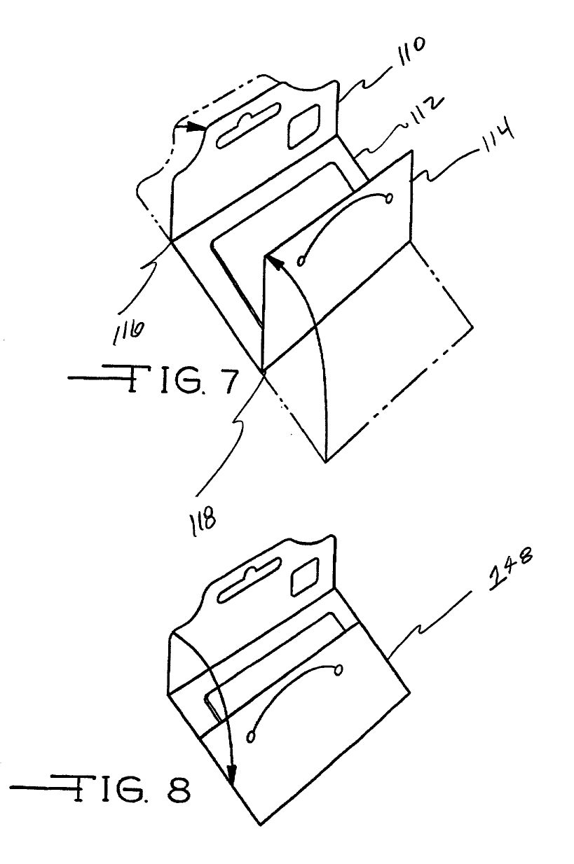

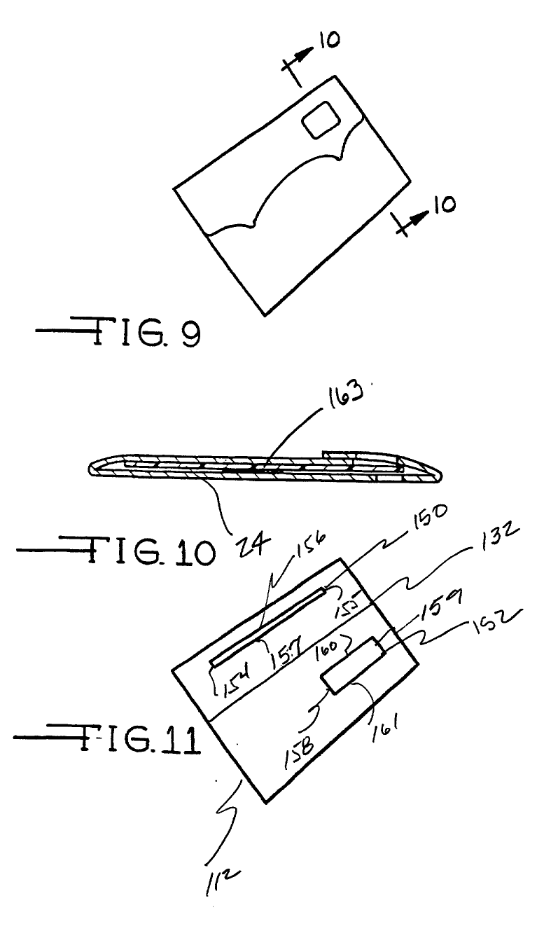

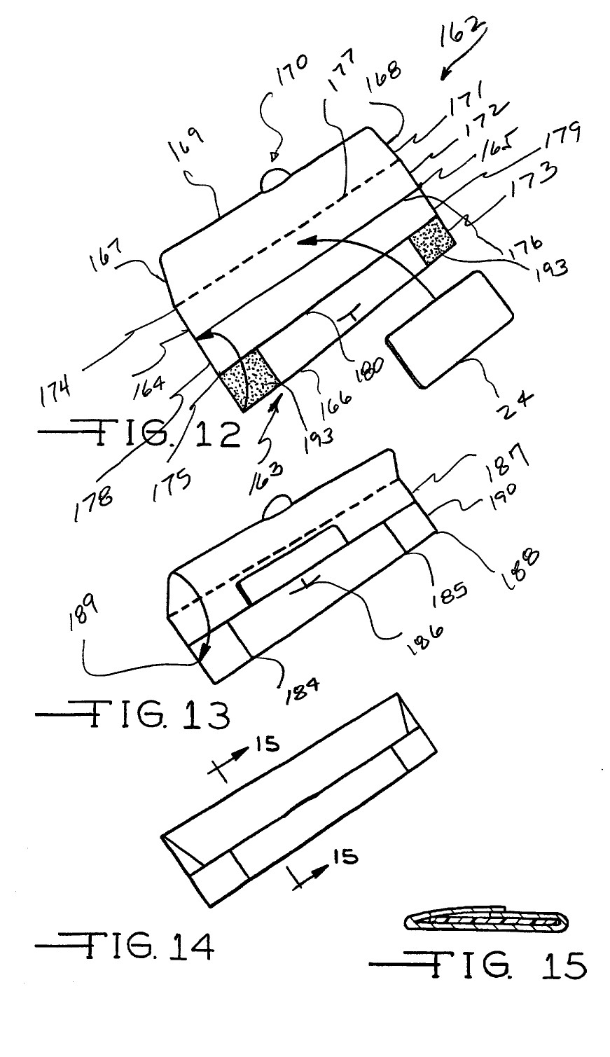

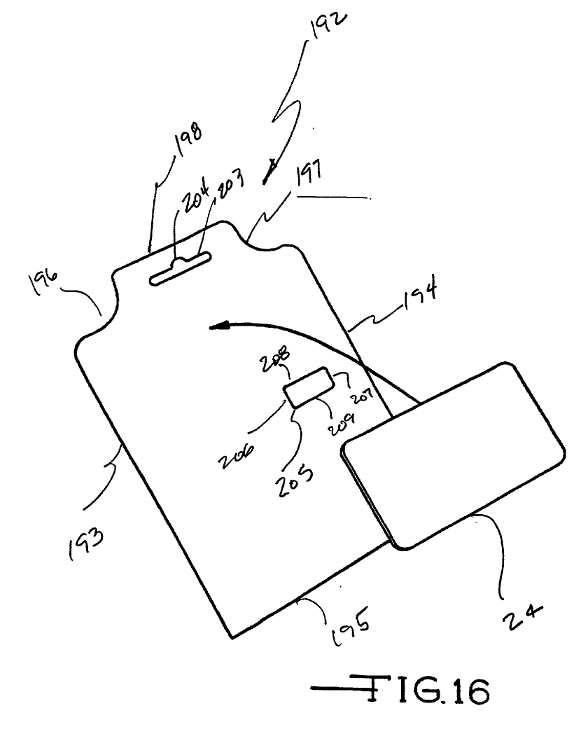

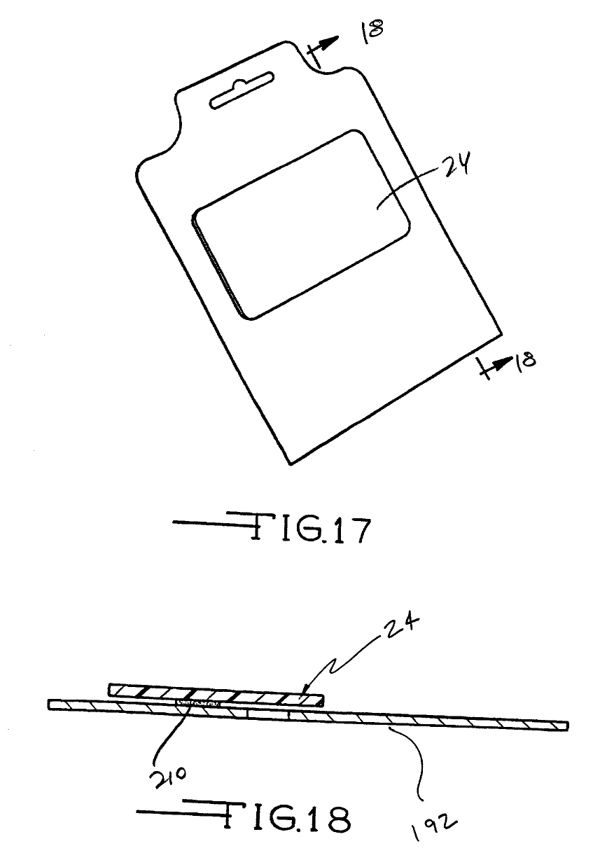

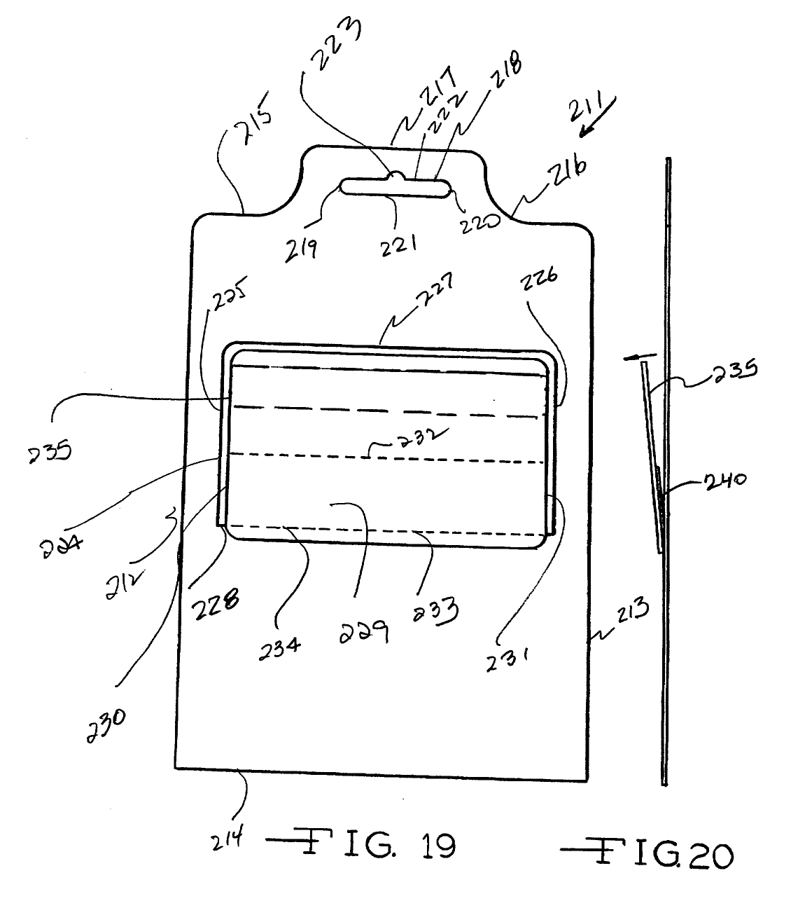

As further shown in FIGS. 2-4, the third panel 44 supports a prepaid credit card 24 used to credit prepaid phone calls, gas purchases and other merchandise and service purchases. The credit card has lower edge 70 parallel to and spaced some what below the lower edge 32 of card 22. The credit card 24 is removably attached to the third panel 44 by an adhesive 41.

In FIGS. 2-4, to close the card 22, the third panel 44 is folded along the fold line 48 doubling the third panel 44, with credit card 24 attached, to the second panel, for a partially closed assembly 72. The first panel 40 is then folded along line of fold 46, on the partially closed assembly 72. Tab 66 is then inserted into the T-slit opening 68.

In FIG. 5, in the fully closed position, credit card 24, attached to the third panel 44 is received inside the first and second panels 40 and 42. The horizontal centerline axis of credit card 24 lies coplanar with horizontal axis of the folded card and perpendicular to edges 28 and 30 of card 22. To open the card 22, the first panel 40 is unfolded from the third panel 44 with the tab 38 being removed from the slit 68. The third panel 44 is then unfolded from the second panel 42 to expose the credit card 24. The credit card is next removed from the third panel 44. The adhesive 41 attaching the credit card 24 to the third panel 44 is easily removed from the credit card.

Also in FIGS. 6 through 11, a second embodiment of the gift card 74 consists of spaced apart side edges 76 and 78, extending downward and meeting with lower edge 80. The side edges also extend up to and meet with concave edges 82 and 84 at rounded corners. Concave edges 82 and 84 extend up to and meet with upper edge 86 at rounded corners. The upper edge 86 is parallel to lower edge 80, perpendicular to side edges 76 and 78 and shorter than lower edge 80. The card 74 may also contain an accent aperture 88 to highlight one or more attributes of the gift card such as card value, when the card 74 is in the closed position. An embodiment of the aperture 88 can be rectangular in shape consisting of spaced apart side edges 90 and 92 extending to and meeting with upper and lower edges 94 and 96 at rounded corners. It can be appreciated by those skilled in the art that a rectangle is shown for illustrative purposes only since other geometric shapes can be used. A horizontal oval opening 98 is located at the midpoint between side edges 76 and 78. The oval opening includes a left curved edge 100 and a right curved edge 102 and upper and lower edges 104 and 106 extending to and meeting with curved edges 100 and 102. Upper edge 104 contains an upwardly curve extension opening 108 at the midpoint. The oval opening can be used to facilitate display of the cards on sales racks and the like.

In FIGS. 7 and 8, the second embodiment of a gift card consists of three panels 110, 112, and 114, separated by lines of fold 116 and 118. The lines of fold 116 and 118 are parallel to each other and are parallel to the upper and lower edges 86 and 80, which are perpendicular to side edges 76 and 78.

The first fold line 116 intersects side edges 76 and 78 and is provided at about the one-third point of the total length of the card. It separates the first and second card panels 110 and 112. The second fold line 118 intersects side edges 76 and 78 and is provided at about the two-thirds point of the length of the card. It separates the second and third panels 112 and 114, of card 74. The lines of fold may be perforated.

For FIGS. 6 through 8, the first panel 110 can be further described by spaced apart edges 120 and 122 extending to and meeting with panel lower edge 124, which coincides with the first fold lines 116. The edges 120 and 122 further extend to and meet with concave edges 82 and 84 at rounded edges. Concave edges 82 and 84 further extend up to and meet with upper edge 86 at rounded corners. Upper edge 86 is shorter then lower edge 124. The upper edge of the first panel 86, is parallel to the lower edge 124.

The second panel of the third embodiment 112 can be further defined by spaced apart edges 126 and 128, extending to and meeting with upper and lower edges 124 and 130. The upper edge 124 coincides with the first line of fold 116, and the lower edge 130 coincides with the second line of fold 118. As shown in FIG. 11, the second panel may contain a line of bend 132 which facilitates the activation of a magnetic strip (not shown), on card 74. The line of bend 132 is parallel to the first and second lines of fold, 116 and 118.

The third panel as shown in FIG. 6, can be further defined by spaced apart edges 134 and 136, extending to and meeting with lower edge 80. Lower edge 80 is parallel to lines of fold 116 and 118. Edges 134 and 136 further extend to and meet with upper edge 130, coinciding with the second fold line 118.

In FIGS. 6 through 9, in the first panel, the upper body of the card 138 defined by concave edges 82 and 84 and upper edge 86, is used as a tab 140. A corresponding semi-elliptical slit 142 in cut equally spaced from edges 134 and 136 in the third panel 114 of the card, the slit extending downward toward the bottom of the card 74. At the ends of the elliptical arc defining the slit 142, continuous circular openings 144 and 146 are cut to facilitate securing the card tab 140 when closed. It can be further appreciated by those skilled in the art that the closure mechanism shown can include a number of different embodiments, and this example is shown for illustrative purposes only.

As further shown in FIGS. 6 through 10 the second part supports a prepaid credit card 24. The credit card 24 is removably secured to the second panel 112 by an adhesive material 163. The credit card has upper and lower edges 144 and 146 parallel to the upper and lower edges 130 and 80 of the second panel 112.

In FIGS. 7 through 9, to close card, the third panel 114 is folded along the second line of fold 118, doubling the third panel 114 upon the second panel 112 containing credit card 24 attached to the second panel 112, creating a partially closed assembly 148. The first panel 110 is then folded along line of fold 116 onto the partially closed assembly 148. Tab 140 is then inserted into the semi-elliptical slot opening 142.

Now in FIG. 10, in the fully closed position, credit card 24 is attached to the second panel 112, and received between the second and third panels 112 and 114. The horizontal centerline axis of credit card 24 lies coplanar with the horizontal axis of the folded card and perpendicular to edges 76 and 78 of card 74.

FIG. 11 shows a rear perspective view of the second panel 112 of card 74. The panel may contain one or more operational slots, designated 150 and 152 as shown in this embodiment. The slots align with the credit card and are used for activation of a magnetic strip or for reading UPC bar codes or for other purposes depending on which credit card is chosen. It can be appreciated by those skilled in the art, that the slots can take a number of shape but for illustration, a rectangular shape is shown. Thus slot 150 in rectangular shape is defined by spaced apart side edges, 154 and 155, extending to and meeting with upper and lower edges 156 and 157 respectively. The second slot 152, is also defined by spaced apart side edges 158 and 159 extending to and meeting with upper and lower edges 160 and 161. The location of the operation slots depend on which area of the surface of the magnetic card is to be read or otherwise be acted upon.

Now in FIGS. 12 through 15, a third embodiment of the prepared gift envelope 162 consists of spaced apart edges 164 and 165 extending downward and meeting with lower edge 166. The side edges 164 and 165 extend up to and meet with acute angular edges 167 and 168. The angle of incidence of side edge 164 and left angular edge 167, and of side edge 165 and right angular edge 168 is greater than 90°, and left angular edge 167 and right angular edge 168 are the same length. The left angular edge 167 extends from the edge 164 to the upper edge 169. The right angular edge 168 extends from the edge 165 to the upper edge 169. Upper edge 169 is parallel to lower edge 166 and is shorter than lower edge 166. A semi-circular tab 170 is located at the center point of the upper edge 169, extending outward from the upper edge, coplanar with the gift card 162.

The third embodiment of the gift card 162 consists of three panels 171, 172, and 173, separated by lines of fold 174 and 175, which are parallel to each other and to upper and lower edges 169 and 166. A first fold line 174 intersects side edges 164 and 165 and is provided at about the one-third point of the length of the card. It separates first and second panels 171 and 172. The second fold line 175 intersects side edges 164 and 165 and is provided at about the two-thirds point of the length of the card. It separates the second and third panels 172 and 173 of card 162. The lines of fold 174 and 175 may be perforated. As will be described in greater detail hereinafter, a bend line 176 intersecting side edges 164 and 165 and parallel to the first and second lines of fold 174 and 175 is used to facilitate removal of the gift card 24 from the envelope 162. The bend line 176 is imprinted as part of the die cutting process.

In FIGS. 12 through 14, the first panel 171 of the envelope 162 can be further delineated by spaced apart left and right angular edges 167 and 168 extending to and meeting with lower edge 177, which coincides with the first fold line 174. This panel is further defined by spaced apart side left and right angular edges 167 and 168 extending to and meeting with upper edge 169. The upper edge 169 of the first panel 171 is parallel to the lower edge 177 and the first and second lines of fold 174 and 175. The upper edge 169 is shorter than lower edge 177.

The second panel 172 of the third embodiment 162, can be further defined by spaced apart edges 178 and 179, extending to and meeting with edges 177 and 180. Edges 177 and 180 coincide with lines of fold 174 and 178.

Furthermore, the third panel 173 can be further defined by spaced apart edges 181 and 182 extending to and meeting with lower edge 183. Lower edge 183 is parallel to lines of fold 174 and 175. Edges 181 and 182 further extend to and meet with upper edge 180 coinciding with the second fold line 175. In FIG. 13, the third panel 173 contains two bend lines 184 and 185, extending from the lower edge 183 to the upper edge 180 coinciding with the second fold line 175. The bend lines are located inward from edges 181 and 182 of the third panel and are perpendicular to the upper and lower edges 180 and 183 of the third panel. The bend lines are used to facilitate removal of the gift card 24 from envelope 162.

In FIGS. 12 through 14, a tab 170 is die cut as part of the main body of the card 163 located at the vertical centerline of the main body of the card, equally distant from edges 164 and 165 at the midpoint of upper edge 169. A corresponding T-shaped slit 186, equally distant from edges 164 and 165, located at the vertical centerline of the card 162, which corresponds to the vertical centerline of tab 170. It can be seen by those skilled in the art that the closure mechanism of the card can include a number of different embodiments and the tab/T-slit combination is used for illustrative purposes only.

As further shown in FIGS. 12 through 14, the third panel 173 is attached to the second panel 172 by a permanent adhesive 193 provided on the third panel between edges 178 and 184 and between edges 179 and 185. This creates a half pocket 187, defined by coinciding edge 188 which is identical to the second line of bend 175 and spaced apart edges 189 and 190. Edges 189 and 190 extend from coinciding lower edge 188 up to upper edge 191. Upper edge 191 is parallel to coinciding lower edge 188 and perpendicular to left and right edges 189 and 190. Credit card 24 used for prepaid phone calls, gas purchases and other merchandise and services purchases is inserted in pocket 187.

In FIGS. 12 through 14, to close card 162, the first panel 171 is folded along the first fold line 174 imposing the first panel 174 upon the pocket half pocket 187, creating a closed envelope 162 which is secured by inserting tab 170 into the slit opening 186.

In FIG. 15, in the fully closed position, credit card 24 is received inside the pocket 187 and the first panel 171. The horizontal axis of credit card 24 lies parallel with the horizontal axis of the folded card and perpendicular to edges 164 and 165 of card 162. To open the envelope, this procedure is reversed. With the panel 171 removed from engagement with the third panel 173, an upper portion of the credit card 24 housed in the half pocket 187 is exposed. A user is then able to reach into the pocket to remove the credit card. As this occurs, the bend line 176 permits an upper portion of the second panel 172 to flex away from the user's fingers to facilitate removal of the credit card from the envelope.

In FIGS. 16 through 18, a fourth embodiment of the gift card 192 is shown. It consists of spaced apart side edges 193 and 194, extending downward and meeting with lower edge 195. The side edges extend up to and meet with concave edges 196 and 197 at rounded corners. Concave edges 196 and 197 in turn extend up to and meet with upper edge 198 at rounded corners. The upper edge 198 is parallel to lower edge 195, perpendicular to side edges 193 and 194 and shorter than lower edge 195. A horizontal oval opening 199 located at the midpoint between side edges 193 and 194 near upper edge 198. The oval opening includes a left curved edge 200 and a right curved edge 201 extending to and meeting with lower edge 202 and upper edge 203. Upper edge 203 contains an upwardly curved opening extension 204 at the midpoint of the edge. The credit card 24 is directly attached to the gift card 192 by a removable adhesive 210.

FIG. 16 shows a perspective view of the fourth embodiment of card 192. This card panel may also contain one or more operational slots designated as 205. This slot 205 is shown generally rectangular in shape. The purpose of the slots has been previously described in other embodiments of the gift card 22,74,192. Slot 205 is defined by spaced apart side edges 206 and 207 extending to and meeting with upper and lower edges 208 and 209. The meeting corners may be rounded. The location of the operational slot 205 depends on which area of the surface of credit card 24 is to be read or otherwise acted upon.

In FIGS. 19 and 20, a fifth embodiment of the gift card 211 is shown. It consists of spaced apart edges 212 and 213, extending downward and meeting with lower edge 214. The side edges extend up to and meet with concave edges 215 and 216 at rounded corners. Concave edges 215 and 216 extend up to and meeting with upper edge 217 at rounded corners. The upper edge 217 is parallel to lower edge 214, is perpendicular to side edges 212 and 213 and shorter than lower edge 214. A horizontal oval opening 218 is located at the midpoint between side edges 212 and 213 near the upper edge 217. The oval opening 218 includes a left curved edge 219 and a right curved edge 220 extending to and meeting with lower edge 221 and upper edge 222. Upper edge 222 contains an upwardly curved opening extension 223 at the midpoint of the upper edge.

FIG. 19 is a plan view of the fifth embodiment of card 211. A generally rectangular opening 224 is located about the midpoint of the card. It consists of spaced apart side edges 225 and 226, extending to and meeting with upper edge 227 at rounded corners and further extending and meeting with lower edge 228. Lower edge contains a flap extension 229 extending upwardly into the rectangular opening 224 consisting of spaced apart side edges 230 and 231 extending to and meeting with flap upper and lower edges 232 and 233. The flap upper edge 232 is smaller than rectangular opening upper edge 227 and the credit card 24 is removably attached to the flap extension 229 by adhesive 240. In FIGS. 19 and 20, a line of bend 234 coincides with the lower edge 233 of the flap extension 229 thereby making the rear area of the credit card accessible to activate a magnetic strip 235 contained on credit card 24 or other similar purposes.

In order to activate the credit card 24, the flap extension 229 is moved in a backwards direction, away from the main body of the card 211. This enables a point of sale person to access and manipulate the credit card 24 to activate it. Once activated, the purchaser is able to remove the credit card from the flap 229 for use.

While the preferred embodiment of the present invention has been disclosed, it will be appreciated that it is not limited thereto, but may be embodied within the scope of the following claims.

I claim:

1. A card envelope supporting a card comprising:
spaced apart side edges extending to and meeting with a lower edge;
said spaced apart side edges further extending to ends meeting with an upper edge;
wherein said upper edge is parallel to said lower edge and perpendicular to said side edges and is shorter then said upper edge; and
said card is secured to the card envelope.

2. A card envelope as in claim 1 further comprising at least one operational slot, said slot being located in relative position to said credit card as to facilitate operational activities on the card.

3. A card envelope according to claim 1, further comprising an opening for hanging the envelope on a display device.

4. A card envelope according to claim 1 further comprising an opening with spaced apart side edges extending to and meeting with an upper edge, further extending and meeting with a lower edge, said lower edge further comprising a flap, wherein said card is secured to the flap.

5. A card envelope according to claim 1, wherein the card can be a credit card, phone card or other card of value.

6. A card envelope supporting a card comprising:
spaced apart side edges extending to and meeting with upper and lower edges whereby said upper edge is parallel to said lower edge and said upper and lower edges are perpendicular to said side edges;
said card envelope further comprising first, second and third panels separated by first and second lines of fold;
wherein said first and third panels containing mated components of a closure mechanism wherein when the card is closed by imposing said third panel upon said second panel creating a partially closed assembly and said first panel is then imposed upon said partially closed assembly and said first panel then is affixed to said third panel by a closure mechanism securing said card within the envelope.

7. A card envelope according to claim 6, said first panel further comprising spaced apart edges extending to and meeting with concave edges; said concave edges further extending to and meeting with said upper edge.

8. A card envelope according to claim 7, further comprising a horizontal oval opening in the first panel, said horizontal oval opening further comprising an upwardly curved opening extension at its midpoint.

9. A card envelope according to claim 6 further comprising at least one operational slot, said slot being located in a relative position to said credit card located within said envelope as to facilitate operational activities on the card.

10. A card envelope according to claim 6, further comprising at least one accent aperture, said accent aperture is located relative to the position of the card in the envelope as to highlight one or more attributes of the card, where the envelope is closed.

11. A card envelope according to claim 6 wherein the closure mechanism is a rounded tab located at the midpoint of said upper edge of the first panel and a T-slit located at a corresponding location in the third panel.

12. A card envelope according to claim 6 wherein the closure mechanism further including the upper body of the card located in the first panel inserted in an arcuate slit further correspondingly located in the third panel.

13. A card envelope according to claim 12, said arcuate slit further comprising continuous circular openings at the ends of said arcuate slit.

14. A card envelope according to claim 6, wherein the card can be a credit card, phone card or other card of value.
